(19) United States
(12) Patent Application Publication
(10) Pub. No.: US 2013/0298132 A1
(43) Pub. Date: Nov. 7, 2013

(54) MULTI-CORE PROCESSOR SYSTEM AND SCHEDULING METHOD

(71) Applicant: Fujitsu Limited, Kawasaki-shi (JP)

(72) Inventors: Koji Kurihara, Kawasaki (JP); Koichiro Yamashita, Hachioji (JP); Takahisa Suzuki, Kawasaki (JP); Hiromasa Yamauchi, Kawasaki (JP); Toshiya Otomo, Kawasaki (JP); Naoki Odate, Akiruno (JP)

(21) Appl. No.: 13/941,141

(22) Filed: Jul. 12, 2013

Related U.S. Application Data
(63) Continuation of application No. PCT/JP2011/050483, filed on Jan. 13, 2011.

(51) Int. Cl. G06F 9/48

(52) U.S. Cl. CPC G06F 9/4881
USPC 718/102

(57) ABSTRACT

A multi-core processor system includes plural processors; and a scheduler that assigns applications to the processors. The scheduler upon receiving a startup request for a given application and based on start times of the applications executed by the processors, selects a processor that is to execute the given application.

### CROSS REFERENCE TO RELATED APPLICATIONS

This application is a continuation application of International Application PCT/JP2011/050483, filed on Jan. 13, 2011 and designating the U.S., the entire contents of which are incorporated herein by reference.

### FIELD

The embodiment discussed herein are related to a multi-core processor system and a scheduling method that control the assignment destination of an application.

### BACKGROUND

In a conventional multi-core processor system, the central processing unit (CPU) to which applications are to be assigned is determined based on the load and priority level of the applications that have been assigned to each CPU (see, for example, Japanese Patent No. 2686438). The order of execution of the applications at each CPU is determined based on the priority levels of the applications.

According to a disclosed technique, power consumption is reduced by grouping applications according to operation frequency and setting the operation frequency of each CPU so that a deadline for each group of applications is met (see, for example, Japanese Laid-Open Patent Application No. 2000-66910).

According to another disclosed technique, power consumption is reduced by controlling the source voltage supplied to each CPU and the clock frequency, based on information concerning applications under execution and based on the order of execution of applications (see, for example, Japanese Laid-Open Patent Application No. 2003-202935).

According to still another disclosed technique, parallel processing among different CPUs is controlled hierarchically by grouping CPUs making up a multi-core processor and equipping a multi-core processor system with a unit that allows each group of CPUs to perform high-speed synchronous processing (see, for example, Japanese Patent Application No. H6-1461).

However, when an assignment destination CPU for a given application and the order of execution of the given application are determined based on the priority level and load of the given application, a problem arises in that the response of an application that the user desires to run is not always good. For example, in the case of a cellular phone, the priority levels of a mailer and phone call application are set higher than the priority level of a game application. When the user starts music playing software while the mailer is running, the user executes an operation for playing music right after the start of the music playing software, but is unlikely to operate the mailer immediately after the start of the operation of the music playing software. If, however, the mailer and the music playing software are assigned to the same CPU in a multi-core processor and the mailer is executed preferentially over the music playing software, a problem arises in that execution of the music playing software, which the user desires to operate, is delayed.

When an assignment destination CPU for a given application is determined based on the priority level and load of the given application, the assignment status of each CPU must be collected from each CPU through inter-processor communication, arising in a problem of increased scheduling overhead.

### SUMMARY

According to an aspect of an embodiment, a multi-core processor system includes plural processors; and a scheduler that assigns applications to the processors. The scheduler upon receiving a startup request for a given application and based on start times of the applications executed by the processors, selects a processor that is to execute the given application.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one embodiment;

FIG. 2 is a block diagram of hardware making up a multi-core processor system;

FIG. 3 is an explanatory diagram of an example of access ratios;

FIG. 4 is an example of a functional block diagram of a multi-core processor system 200;

FIG. 5 is an explanatory diagram of an example of an assignment of an application;

FIG. 6 is an explanatory diagram of an example of a management table 600;

FIG. 7 is an explanatory diagram of a start time table 700;

FIG. 8 is an explanatory diagram of an example of reception of a startup instruction for application #5;

FIG. 9 is an explanatory diagram of an example of execution of the application #5;

FIG. 10 is an explanatory diagram of an example of updating of the management table 600;

FIG. 11 is an explanatory diagram of an example of updating a start time in the start time table 700;

FIG. 12 an explanatory diagram of an example of updating of a virtual processor ID in the start time table 700;

FIG. 13 is an explanatory diagram of an example of updating an access ratio and a clock frequency in the start time table 700;

FIG. 14 is an explanatory diagram of an example of control of access ratios and clock frequencies during execution of the application #5;

FIG. 15 is an explanatory diagram of an example of updating of the start time table 700 after an elapse of a given time;

FIG. 16 is an explanatory diagram of an example of setting access ratios and clock frequencies after an elapse of the given time;

FIG. 17 is a flowchart of a procedure of an assignment process by a scheduler 231; and

FIG. 18 is a flowchart of a procedure of a setting process by each scheduler.

### DESCRIPTION OF EMBODIMENTS

Preferred embodiments of a multi-core processor system and a scheduling method according to the present invention will be described in detail. In the multi-core processor system, a multi-core processor is a processor equipped with multiple cores. Nonetheless, provided that multiple cores are provided, a single processor equipped with multiple cores or a group of parallel single-core processors may be regarded as such a multi-core processor. In the embodiments, to simplify description, a group of parallel single-core processors will be taken as an example.

After starting an application, the user is assumed to desire to operate the application. For example, in the case of a cellular phone, upon receiving an e-mail while playing music by music playing software, the cellular phone starts a mailer and the user views the incoming e-mail. When the user views a Web homepage for which a URL link is attached to the e-mail, a browser is started. The user, therefore, is highly likely to operate the browser. The user is also likely to operate the mailer involved in the start of the browser. Hence, the user is least likely to use the music playing software. In this manner, in the embodiments, it is concluded that the user is likely to operate an application that was started after other applications for which a start instruction is issued.

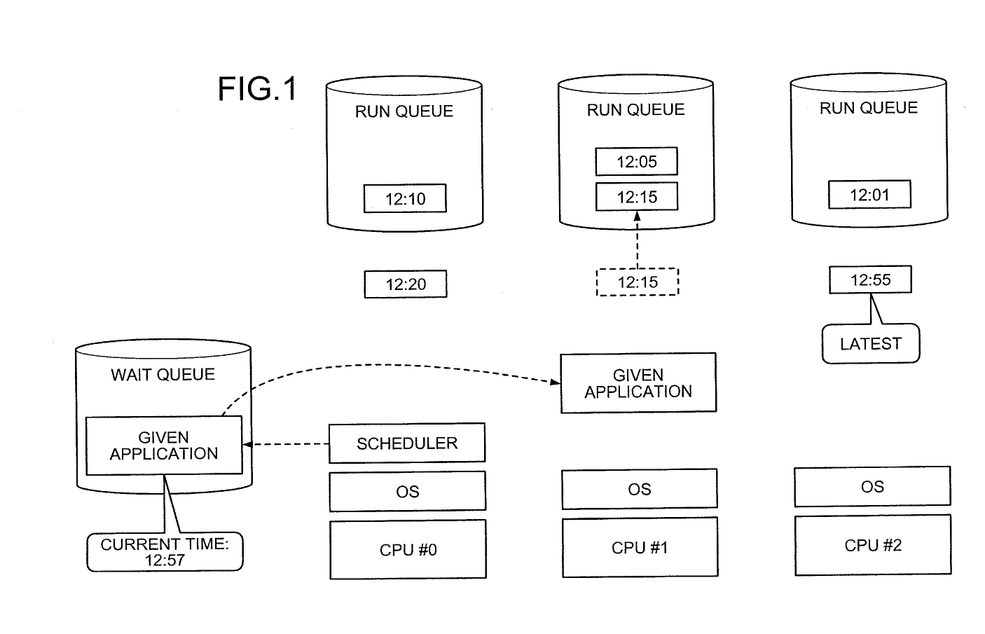

FIG. 1 is an explanatory diagram of one embodiment of the present invention. In FIG. 1, at a CPU #0, an application having a start time of 12:20 is under execution and an application having a start time of 12:10 is registered in a run queue. At a CPU #1, an application having a start time of 12:15 is under execution and an application having a start time of 12:05 is registered in a run queue. At a CPU #2, an application having a start time of 12:55 is under execution and application having a start time of 12:01 is registered in a run queue. Although each start time is expressed in terms of hours and minutes in FIG. 1, the format is not limited hereto. Each time may be expressed more specifically in terms of dates, hours, minutes, and seconds.

Each OS in FIG. 1 has a run queue, in which a pointer for context information of an assigned application is stacked. Context information is information including, for example, the execution status of a loaded application and variables in the application. By acquiring a pointer for context information in the run queue and accessing the context information of the application, each OS can execute the application immediately.

An OS that runs on the CPU #0 is a master OS. The master OS has a scheduler that determines an assignment destination CPU for a given application for which a startup instruction has been received. The master OS further has a wait queue. When a pointer for binary information of application is stacked in the wait queue, the scheduler determines that a startup instruction for the given application has been received. The scheduler then identifies a core from among the cores of the multi-core processor, exclusive of the core that is an assignment destination for the application having the latest start time among applications that have been assigned to the CPUs. The application having the latest start time among the applications assigned to the CPUs is the application for which the time that has elapsed since the start of the application is shortest. Thus, the user is likely to use this application.

The application having the latest start time among the applications assigned to the CPUs is the application assigned to the CPU #2 and having the start time of 12:55. The CPUs other than the CPU #2, which is the assignment destination CPU of the application having the start time of 12:55, are the CPU #0 and the CPU #1, among which, the CPU #1 is identified in the example depicted in FIG. 1. The scheduler saves to the run queue, the application that has the start time of 12:15 and is under execution at the CPU #1, and causes the CPU #1 to execute the given application.

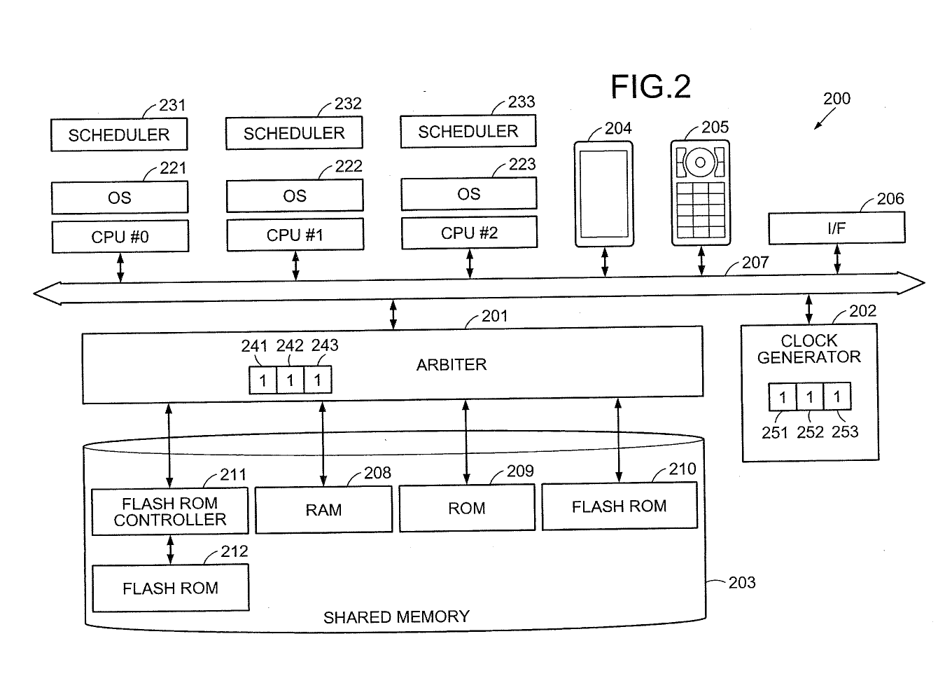

FIG. 2 is a block diagram of hardware making up a multi-core processor system. In FIG. 2, a multi-core processor system 200 includes the CPU #0, the CPU #1, and the CPU #2. The multi-core processor system 200 also includes a keyboard 205, a display 204, an interface (I/F) 206, an arbiter 201, shared memory 203, and a clock generator 202. The CPU #0, the CPU #1, the CPU #2, the keyboard 205, the display 204, the I/F 206, the arbiter 201, and the clock generator 202 are interconnected through a bus 207.

Each of the CPU #0, the CPU #1, and the CPU #2 has a register, a core, and a cache. The core has a computing function. The register in each CPU has a program counter (PC) and a reset register.

The cache in each CPU is memory that operates faster and has a smaller capacity than the shared memory 203. The cache in each CPU, for example, temporarily stores data read out from the shared memory 203. The cache in each CPU, for example, temporarily stores data to be written to the shared memory 203. The cache in each CPU is connected to a different CPU via a snoop circuit, which has a function such that when data shared between different caches is updated by any one of the caches, the snoop circuit detects the updating and updates the data in the other caches.

The CPU #0 serves as a master CPU, supervising overall control over the multi-core processor system 200 and executing an operating system (OS) 221. The OS 221 serves as the master OS, executing threads assigned to the CPU #0. The OS 221 has a scheduler 231, which has a function of performing control for determining to which CPU, an application for which a startup instruction has been received is to be assigned. The scheduler 231 also has a function of controlling the order of execution of applications assigned to the CPU #0.

The CPU #1 serves as a slave CPU, executing an OS 222. The OS 222 serves as a slave OS, executing threads assigned to the CPU #1. The OS 222 has a scheduler 232, which has a function of controlling the order of execution of applications assigned to the CPU #1. The CPU #2 serves as a slave CPU, executing an OS 223. The OS 223 serves as a slave OS, executing threads assigned to the CPU #2. The OS 223 has a scheduler 233, which has a function of controlling the order of execution of applications assigned to the CPU #2.

The display 204 displays a cursor, icons, tool boxes, document/image data, and functional information. The display 204 may be provided as, for example, a TFT liquid crystal display 204, etc.

The keyboard 205 has keys for entering figures, various instructions, etc., and is used for inputting data. The keyboard 205 may be provided as a touch panel type input pad or numeric keypad.

The I/F 206 is connected to a network, such as local area network (LAN) and wide area network (WAN), via a communication line, and is connected to external devices via the network. The I/F 206 supervises interface between the network and the system, and controls the input and output of data with respect to an external device. The I/F 206 may be provided as a modem, LAN adaptor, etc.

The shared memory 203 is memory shared by the CPU #0, CPU #2 and CPU #1. For example, the shared memory 203 has read only memory (ROM) 209, random access memory (RAM) 208, flash ROM 210, a flash ROM controller 211, flash ROM 212, etc.

The ROM 209 stores programs, such as a boot program. The RAM 208 is used as a work area of the CPU. The flash ROM 210 stores system software and applications, such as the OSs 221 to 223, and a management table and a start time table, which will be described later. For example, when updating an OS, the multi-core processor system 200 receives a new OS through the I/F 206, and replaces the old OS stored in the flash ROM 210 with the received new OS.

The flash ROM controller 211, under the control of the CPUs, controls data the reading and writing of data with respect to the flash ROM 212. The flash ROM 212 stores data written thereto under the control of the flash ROM controller 211. Examples of data include image/audio data that the user of the multi-core processor system 200 acquires through the I/F 206. The flash ROM 212 may be provided as, for example, a memory card, SD card, etc.

The arbiter 201 arbitrates access requests from the CPUs to the shared memory 203. The arbiter 201 has registers 241 to 243 that can set access ratios for access of shared memory 203 by the CPUs. The access ratios are the ratios for controlling the frequency of access of the shared memory 203. The access ratio of the CPU #0 is set in the register 241; the access ratio of the CPU #1 is set in the register 242; and the access ratio of the CPU #2 is set in the register 243.

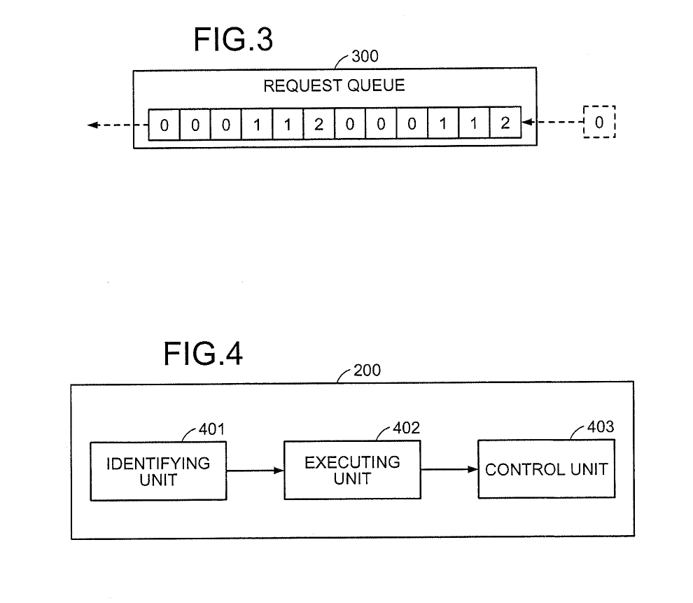

FIG. 3 is an explanatory diagram of an example of access ratios. In the example depicted in FIG. 3, a value in the register 241 is 3, a value in the register 242 is 2, and a value in the register 243 is 1. In FIG. 3, each box in a request queue 300 represents an access request. The arbiter 201 receives access requests sequentially from the right side of the request queue 300 and processes access requests sequentially from the left side of the request queue 300.

In the request queue 300, boxes indicating “0” represent access requests from the CPU #0, boxes indicating “1” represent access requests from the CPU #1, and boxes indicating “2” represent access requests from the CPU #2. From the left side toward the right side of the request queue 300, a row of three boxes indicating “0” is followed by a row of two boxes indicating “1”, which is followed by one box indicating “2”, which is then followed by another row of three boxes indicating “0”.

This indicates that the arbiter 201 processes three access requests from the CPU #0, and processes two access requests from the CPU #1, and then processes one access request from the CPU #2. FIG. 2 is referred to again. In FIG. 2, an initial value of “1” is set in each of the registers 241 to 243.

The clock generator 202 is a clock generating circuit that supplies a clock to each component. In this embodiment, clocks of a frequency of 100 [MHz], 200 [MHz], and 300 [MHz] can be supplied to each CPU. For example, the clock generator 202 has registers 251 to 253 that can set each clock frequency to be supplied to each CPU.

“1” in the register 251 indicates that a clock of 100 [Hz] is supplied to the CPU #0. “2” in the register 251 indicates that a clock of 200 [Hz] is supplied to the CPU #0. “3” in the register 251 indicates that a clock of 300 [Hz] is supplied to the CPU #0.

“1” in the register 252 indicates that a clock of 100 [Hz] is supplied to the CPU #1. “2” in the register 252 indicates that a clock of 200 [Hz] is supplied to the CPU #1. “3” in the register 252 indicates that a clock of 300 [Hz] is supplied to the CPU #1.

“1” in the register 253 indicates that a clock of 100 [Hz] is supplied to the CPU #2. “2” in the register 253 indicates that a clock of 200 [Hz] is supplied to the CPU #2. “3” in the register 253 indicates that a clock of 300 [Hz] is supplied to the CPU #2. In the example depicted in FIG. 2, the values of each of the registers are set to the initial value of “1”.

FIG. 4 is an example of a functional block diagram of the multi-core processor system 200. The multi-core processor system 200 includes an identifying unit 401, an executing unit 402, and a control unit 403. For example, a program having the identifying unit 401 to the control unit 403 is stored in a memory device, such as the shared memory 203. A specific CPU in the multi-core processor system 200 accesses the memory device, reads out the program, and in the scheduler 231, executes a process. In this manner, processing by the identifying unit 401 to the control unit 403 is executed. In this embodiment, for example, the specific CPU is the CPU #0, and the read program is the scheduler 231.

When a startup instruction for a given application is received, the identifying unit 401 identifies a CPU other than the CPU that is an assignment destination for the application having the latest start time among the applications assigned to the CPUs in the multi-core processor. The identifying unit 401 may identify the CPU that is the assignment destination for the application having the earliest start time among the applications having the latest start times among the applications assigned to the CPUs.

The executing unit 402 executes the given application in place of the application under execution by the CPU identified by the identifying unit 401.

The control unit 403 increases the frequency of the clock supplied to the CPU identified by the identifying unit 401, to a frequency that is higher than the frequencies of the clocks supplied to the other CPUs of the multi-core processor. The control unit 403 sets the frequency of the clock supplied to the identified CPU, to the highest frequency among suppliable clock frequencies.

If a startup instruction for different application is not received after an elapse of a given time from the start of the given application, the control unit 403 sets the frequencies of clocks to be supplied to the CPUs of the multi-core processor, to a same frequency. The control unit 403 may set the frequencies of clocks to be supplied to the CPUs of the multi-core processor, to the lowest frequency among the frequencies of clocks supplied to the CPUs of the multi-core processor.

The control unit 403 sets the access ratio for the access of a shared resource in the multi-core processor by the CPU identified by the identifying unit 401, to an access ratio that is greater than the access ratios for the access of the shared resource by the other CPUs of the multi-core processor. In this embodiment, the shared resource is the shared memory.

If a startup instruction for different application is not received after an elapse of a given time from the start of the given application, the control unit 403 sets the access ratios for the access of the shared memory by the CPUs of the multi-core processor, to a same access frequency. Based on the above description, detailed examples will be given.

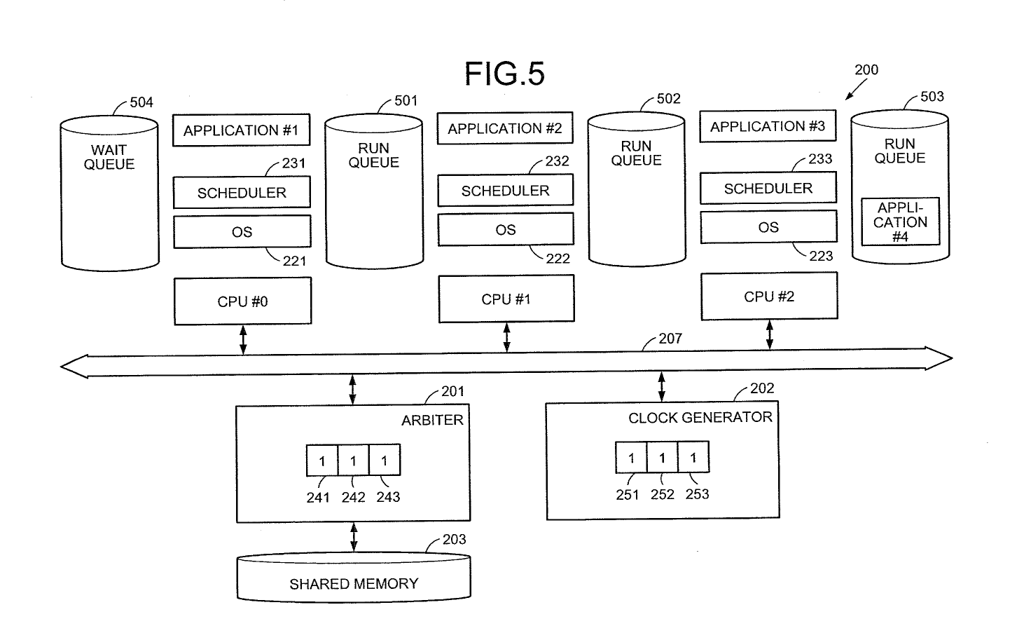

FIG. 5 is an explanatory diagram of an example of an assignment of an application. FIG. 5 does not depict the display 204, the keyboard 205, the I/F 206, the flash ROM controller 211, the flash ROM 210, the RAM 208, the ROM 209, or the flash ROM 212. In FIG. 5, the application #1 is assigned to the CPU #0; the application #2 is assigned to the CPU #1; and the application #3 and #4 are assigned to the CPU #2. The master OS 221 has a wait queue 504. When a pointer for binary information of an application is stacked in the wait queue 504, the scheduler 231 determines that a startup instruction for the application has been received.

The OS 221 has a run queue 501; the OS 222 has a run queue 502, and the OS 223 has a run queue 503. In each run queue, a pointer for context information of application is stacked. When an OS has completed the execution of an application, the OS executes another application if a pointer for context information of another application is stacked in the run queue. For example, since the application #3 is under execution by the CPU #2, a pointer for context information of the application #4 is stacked into the run queue 503.

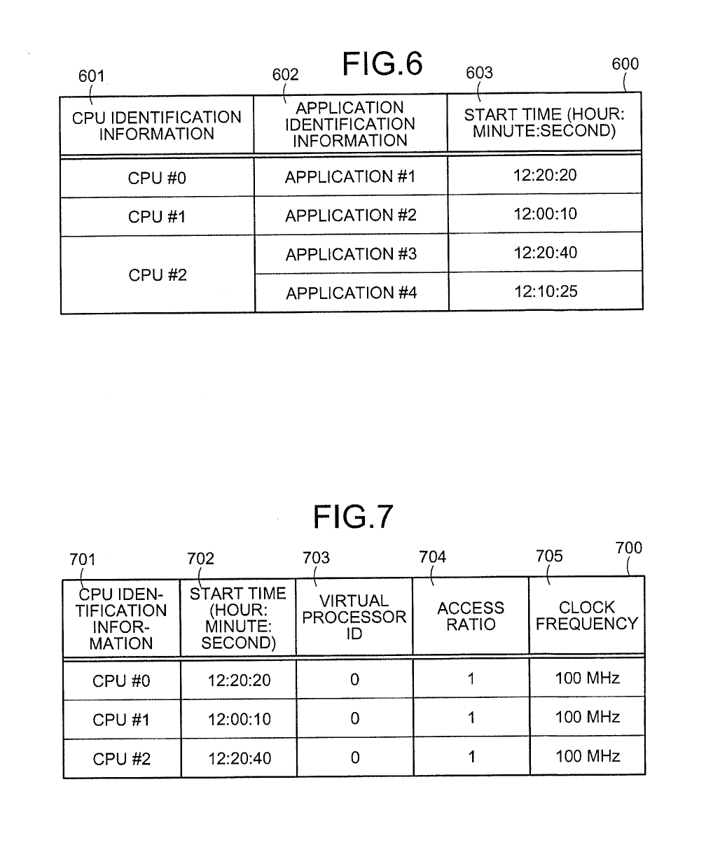

FIG. 6 is an explanatory diagram of an example of a management table. A management table 600 has a CPU identification information field 601, an application identification information field 602, and a start time field 603. Identification information of a CPU is registered in the CPU identification information field 601. Identification information of an application assigned to the CPU identified by identification information registered in the CPU identification information field 601 is registered in the application identification information field 602. The start time of the application identified by the identification information registered in the application identification information field 602 is registered in the start time field 603. The start time is expressed as “(hour):(minute):(second)”.

For example, when “CPU #0” is registered in the CPU identification information field 601, “application #1” is registered in the corresponding application identification information field 602, and “12:20:20” is registered in the corresponding start time field 603, this indicates that the application #1, which started at 20 minutes and 20 seconds after twelve, is assigned to the CPU #0.

As described above, the management table 600 is stored in a memory device, such as the flash ROM 210, and may be stored in the cache of each CPU. When the contents of the management table 600 in the cache of one CPU changes, the snoop circuit detects the change in the contents of the management table 600 and changes the contents of the management tables 600 in the caches of the other CPUs.

FIG. 7 is an explanatory diagram of a start time table. A start time table 700 has a CPU identification information field 701, a start time field 702, a virtual processor ID field 703, an access ratio field 704, and a clock frequency field 705. Identification information of a CPU is registered in the CPU identification information field 701. The start time of the application assigned to the CPU last among the applications assigned to the CPU is registered in the start time field 702. The application assigned to the CPU last is the application having the latest start time.

In descending order of the recency of the start times registered in the start time field 702, the rank given to the CPU is registered in the virtual processor ID field 703. In the present example, an initial value “0” is registered in each virtual processor ID field 703.

The access ratio set in the arbiter 201 is registered in the access ratio field 704. The access ratio is determined based on the values registered in the virtual processor ID fields 703. The value of the access ratio is determined to be larger in ascending order of the values in the virtual processor ID fields 703. If all the values in the virtual processor ID field 703 are equal, the access ratios of all the CPUs are equal.

The frequency of the clock supplied to the CPU is registered in the clock frequency field 705. The frequency of the clock supplied to the CPU is determined based on the values in the virtual processor ID fields 703.

As described above, the start time table 700 is stored in a memory device, such as the flash ROM 210, and may be stored in the cache of each CPU. When the contents of the start time table 700 in the cache of one CPU changes, the snoop circuit detects the change in the contents of the start time table 700 and changes the contents of the start tables 700 in the caches of the other CPUs.

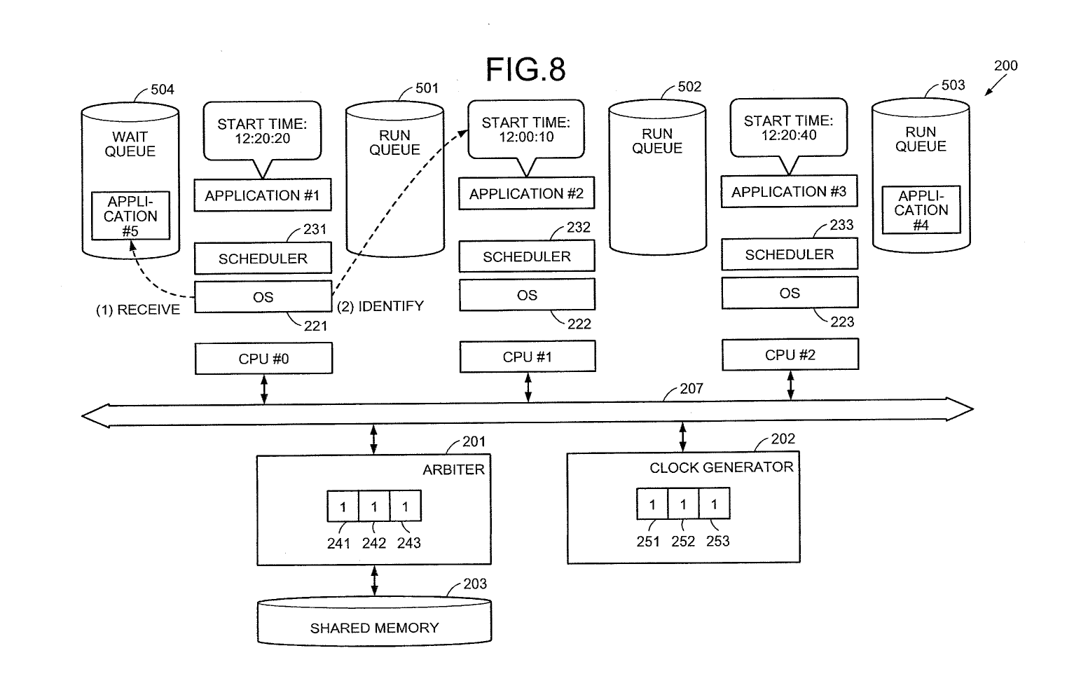

FIG. 8 is an explanatory diagram of an example of reception of a startup instruction for application #5. When a pointer for binary information of the application #5 is stacked in the wait queue 504, the scheduler 231 (1) determines that a startup instruction for the application #5 has been received. The scheduler 231 (2) identifies the CPU having the earliest start time among the start times registered in the start time field 702 in the start time table 700. In the present example, the CPU #1 is identified.

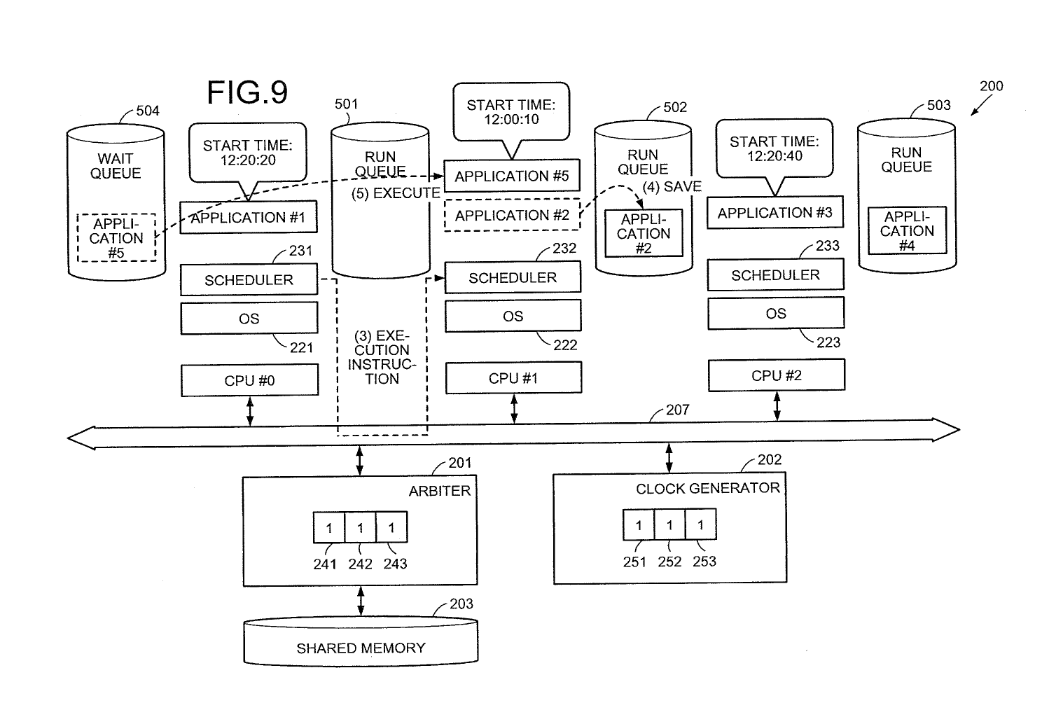

FIG. 9 is an explanatory diagram of an example of execution of the application #5. The scheduler 231 (3) reports the execution instruction for the application #5 to the CPU #1. The execution instruction for the application #5 includes the value of the pointer for the binary information of the application #5 that is in the wait queue 504. Upon receiving the execution instruction for the application #5, the scheduler 232 (4) saves to the run queue 502, the application #2 that is under execution. Based on the value of the pointer for the binary information of the application #5, the scheduler 232 loads the binary information of the application #5 from the shared memory 203. Based on the loaded binary information of the application #5, the scheduler 232 (5) executes the application #5.

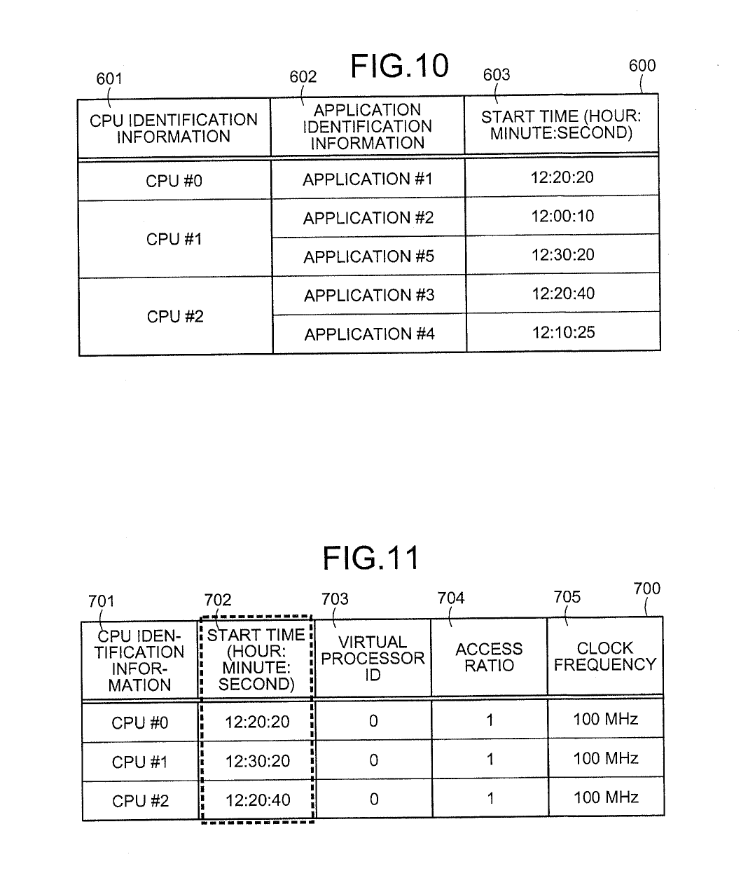

FIG. 10 is an explanatory diagram of an example of updating of the management table 600. The scheduler 232 adds “application #5” to the application identification information field 602 for the CPU #1, in the management table 600. The scheduler 232 detects the current time, and enters the current time in the start time field 603 for the application #5, in the management table 600. In FIG. 10, “12:30:20” is registered as the start time of the application #5.

FIG. 11 is an explanatory diagram of an example of updating a start time in the start time table 700. The scheduler 232 updates the start time in the start time field 702 for the CPU #1, in the start time table 700, to the detected current time. As a result, the start time in the start time field 702 for the CPU #1 is updated to the start time of application assigned last among the applications assigned to the CPU #1.

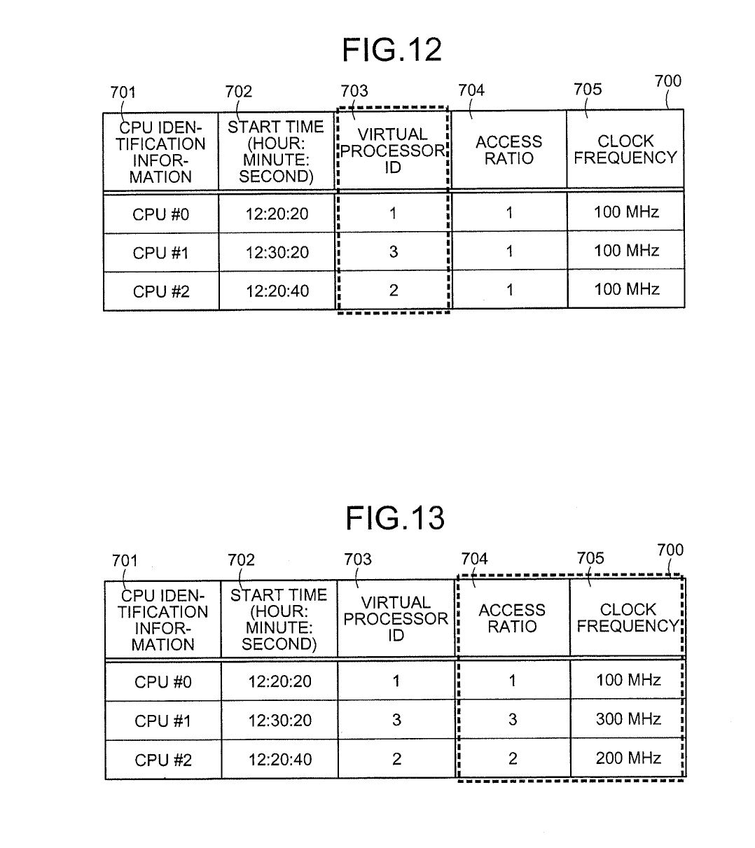

FIG. 12 an explanatory diagram of an example of updating of a virtual processor ID in the start time table 700. The scheduler 232 enters into the virtual processor ID field 703, numbers that are in ascending order of the recency of the start times registered in the start time fields 702 in the start time table 700. In FIG. 12, since the start time for the CPU #0 is the earliest, “1” is registered in the virtual processor ID field 703 for the CPU #0. The start time for the CPU #2 is the second earliest and thus, “2” is registered in the virtual processor ID field 703 for the CPU #2. The start time for the CPU #1 is the latest and thus, “3” is registered in the column of the virtual processor ID field 703 for the CPU #1.

FIG. 13 is an explanatory diagram of an example of updating an access ratio and a clock frequency in the start time table 700. The scheduler 232 determines the access ratio of each CPU based on each number in the virtual processor ID fields 703. For example, the scheduler 232 sets the access ratio of the CPU for which the highest number is registered in the virtual processor ID field 703, to an access ratio higher than the access ratios of the other CPUs.

For example, the scheduler 232 determines the access ratios of the CPUs so that the larger number in the virtual processor ID field 703 is, the higher the access ratio is, and enters the determined access ratios in the access ratio fields 704 for the CPUs. In the present example, the same values registered in the virtual processor ID fields 703 are assumed to be registered in the access ratio fields 704.

The scheduler 232 determines the frequency of each clock supplied to each CPU based on the numbers in the virtual processor ID fields 703. For example, the scheduler 232 sets the frequency of a clock supplied to a CPU for which the highest number is registered in the virtual processor ID field 703, to a frequency higher than the frequencies of the clocks supplied to the other CPUs.

In another case, for example, the scheduler 232 sets the frequency of the clock supplied to the CPU for which the highest number is registered in the virtual processor ID field 703, to the highest frequency among the frequencies that the clock generator 202 can supply. Thus, the scheduler 232 sets the frequency of the clock supplied to the CPU #1, to 300 [MHz]. For example, the scheduler 232 determines the frequencies of the clocks supplied to the CPUs so that the higher the number in the virtual processor ID field 703 is, the higher the corresponding clock frequency is. The scheduler 232 registers the determined clock frequencies into the clock frequency fields 705 for the CPUs in the start time table 700.

In FIG. 13, the scheduler 232 determines clock frequencies such that the frequency of the clock supplied to the CPU #1 is the highest among the frequencies of clocks supplied to the CPUs and that the frequency of the clock supplied to the CPU #2 is the second highest frequency of the clock supplied to the CPU #1. Thus, the scheduler 232 determines the frequency of the clock supplied to the CPU #0 to be the lowest frequency among the frequencies of the clocks supplied to the CPUs.

As described above, the frequencies of clocks that can be supplied to the CPUs according to the present embodiment are 100 [MHz], 200 [MHz], and 300 [MHz]. For example, the scheduler 232 determines the frequencies of the clocks supplied to the CPU #1, CPU #2, and CPU #0 to be 300 [MHz], 200 [MHz], and 100 [MHz], respectively. The scheduler 232 thus registers “300 [MHz]” into the clock frequency field 705 for the CPU #1, “200 [MHz]” into the clock frequency field 705 for the CPU #2, and “100 [MHz]” into the clock frequency field 705 for the CPU #0.

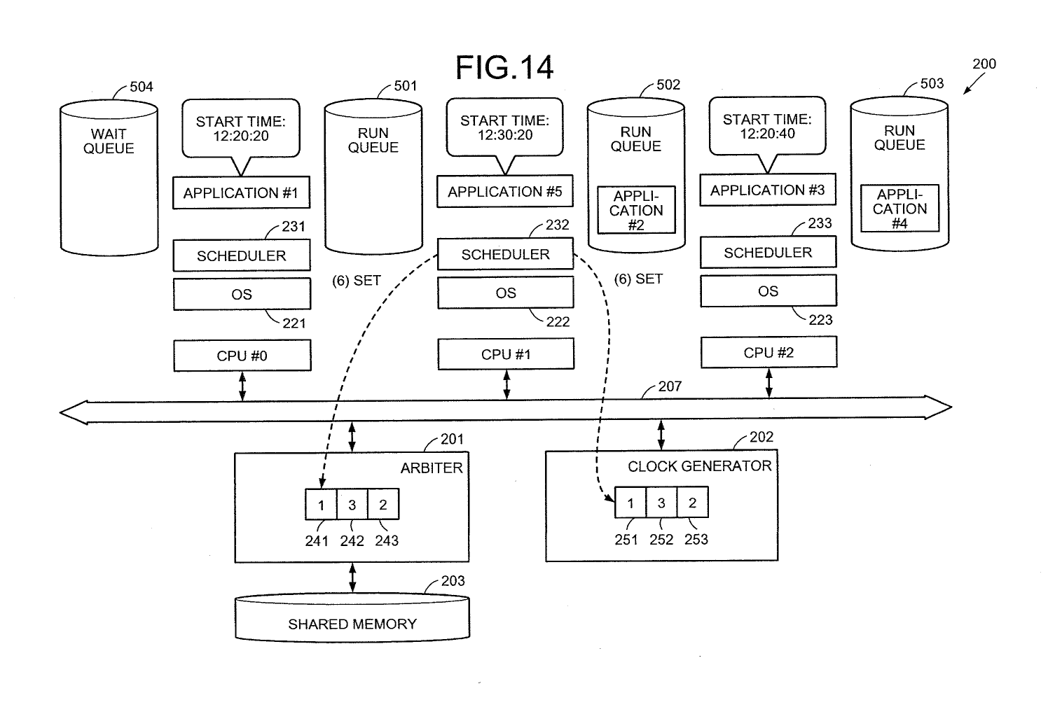

FIG. 14 is an explanatory diagram of an example of control of access ratios and clock frequencies during execution of the application #5. The scheduler 232 (6) sets the access ratio of each CPU registered in the updated start time table 700, in each of the registers 241 to 243 of the arbiter 201 and thereby, controls the access ratios for access of the shared memory 203 by each CPU. “1” is registered in the register 241, “3” is registered in the register 242, and “2” is registered in the register 243.

The scheduler 232 (6) sets in each of the registers 251 to 253 of the clock generator 202, each number corresponding to the clock frequency of each CPU registered in the start time table 700 and thereby, controls the frequency of each clock supplied to each CPU. “1” is registered in the register 251, “3” is registered in the register 252, and “2” is registered in the register 253.

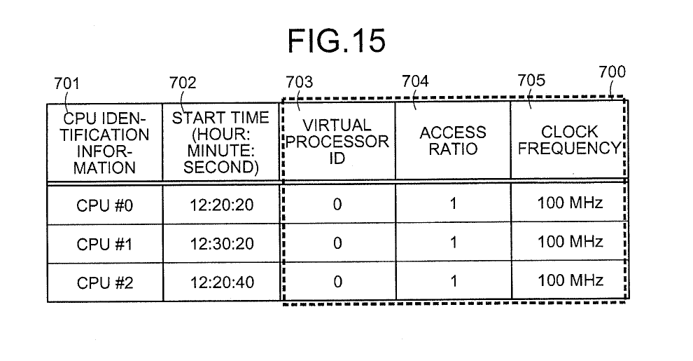

FIG. 15 is an explanatory diagram of an example of updating of the start time table 700 after an elapse of a given time. When the given time has elapsed since the time of the last reception of an application startup request, the scheduler 213 updates the numbers in each of the virtual processor ID fields 703, to “0”. The scheduler 231 updates the access ratios in each of the access ratio fields 704, to “1”, and updates the frequencies in each of the clock frequency fields 705, to “100 [MHz]”.

Right after the start of an application, the possibility of the user using the application is high. When a given time has elapsed, however, the application that the user is going to use becomes uncertain. According to this embodiment, when the given time has elapsed, the ratios for access of the shared memory 203 and the clock frequencies are each set to a same access ratio and a same clock frequency. For example, the given time may be a fixed time, or may be set variably according to the application for which a startup request is issued last.

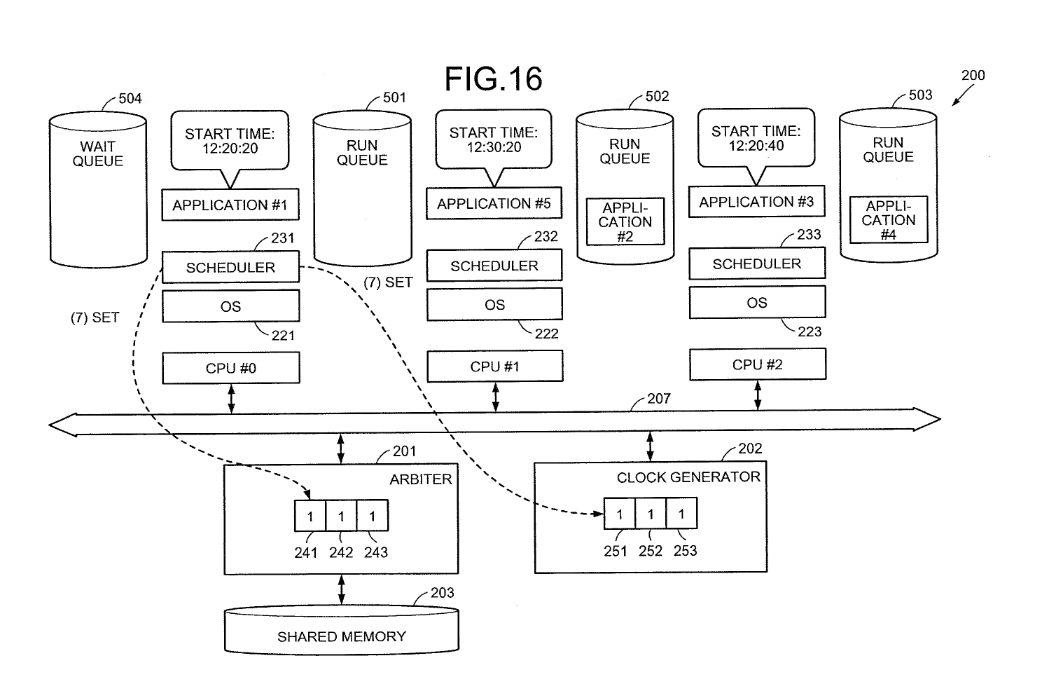

FIG. 16 is an explanatory diagram of an example of setting access ratios and clock frequencies after an elapse of the given time. The scheduler 231 (7) sets in the registers 241 to 243 of the arbiter 201, the access ratios of the CPUs registered in the updated start time table 700. “1” is registered in each of the register 241, the register 242, and the register 243.

The scheduler 231 (7) sets in the registers 251 to 253 of the clock generator 202, the numbers corresponding to the clock frequencies of the CPUs registered in the start time table 700. “1” is registered in each of the register 251, the register 252, and the register 253.

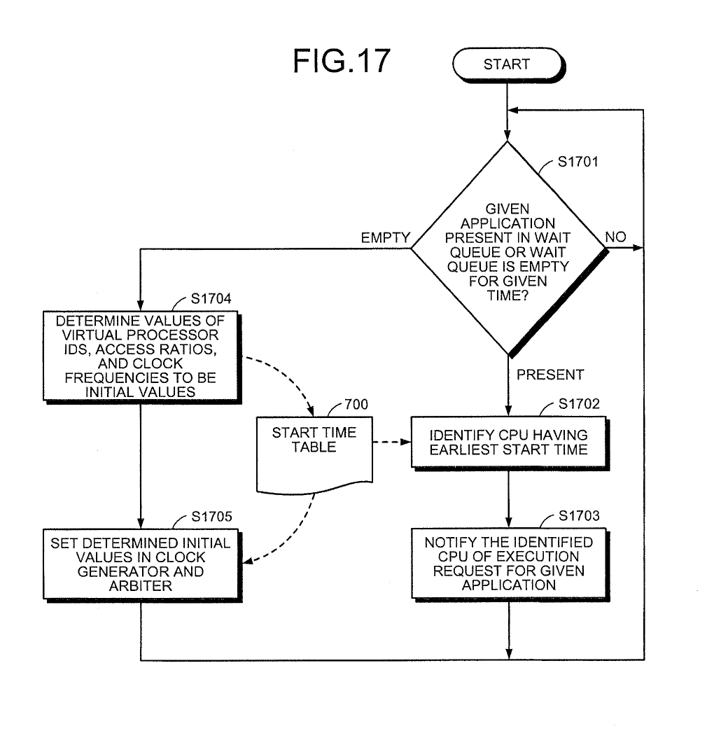

FIG. 17 is a flowchart of a procedure of an assignment process by the scheduler 231. The scheduler 231 determines whether a given application is present in the wait queue 504 or whether the wait queue 504 is empty for a given time (step S1701). Upon determining that the given application is not present in the wait queue 504 and the wait queue 504 is not empty for the given time (step S1701: NO), the scheduler 231 returns to step S1701.

Upon determining that the given application is present in the wait queue 504 (step S1701: PRESENT), the scheduler 231 identifies the CPU having the earliest start time, based on the start time table 700 (step S1702). The scheduler 231 notifies the identified CPU of an execution request for the given application (step S1703), and returns to step S1701.

Upon determining that the wait queue 504 is empty for the given time (step S1701: EMPTY), the scheduler 231 determines the values of the virtual processor IDs, access ratios, and clock frequencies to be initial values (step S1704). The scheduler 231 sets the determined initial values in the registers of the clock generator 202 and the arbiter 201 (step S1705), and returns to step S1701.

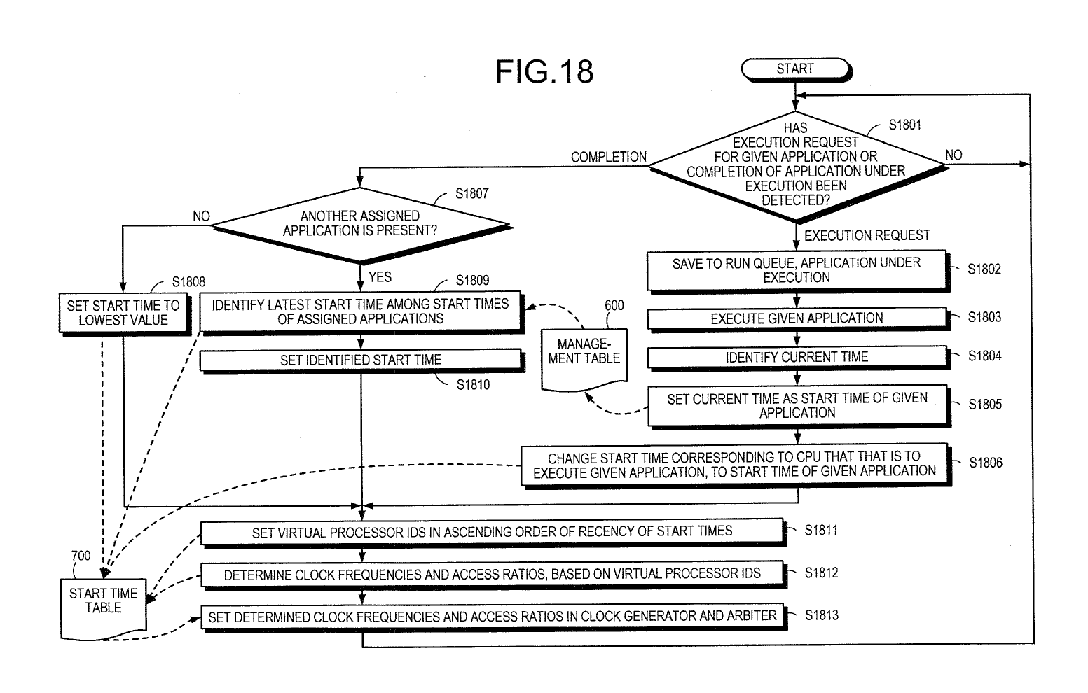

FIG. 18 is a flowchart of a procedure of a setting process by each scheduler. The scheduler determines whether an execution request for a given application or completion of an application under execution has been detected (step S1801). If the scheduler determines that neither an execution request nor the completion of an application under execution has been detected (step S1801: NO), the scheduler returns to step S1801. If the scheduler determines that an execution request for a given application has been detected (step S1801: EXECUTION REQUEST), the scheduler saves to the run queue, an application under execution (step S1802).

The scheduler executes the given application (step S1803), and identifies the current time (step S1804). The scheduler sets the current time in the management table 600, as the start time of the given application (step S1805). The scheduler changes in the start time table 700, the start time corresponding to the CPU that is to execute the given application, to the start time of the given application (step S1806), and proceeds to step S1811.

If the scheduler determines at step S1801 that the completion of an application under execution has been detected (step S1801: COMPLETION), the scheduler determines whether another assigned application is present (step S1807). Upon determining that no other assigned application is present (step S1807: NO), the scheduler sets the start time to the lowest value (step S1808), and proceeds to step S1811. The lowest value is, for example, “0”. When a startup instruction for the given application is received, if a CPU for which the start time is set to “0” in the start time table 700 is present, the given application may be assigned to that CPU.

Upon determining that another assigned application is present (step S1807: YES), the scheduler identifies the latest start time among the start times of the assigned applications (step S1809). The scheduler sets the identified start time (step S1810) and sets virtual processor IDs in ascending order of the recency of the start times in the start time table 700 (step S1811). The scheduler then determines clock frequencies and access ratios, based on the virtual processor IDs (step S1812). The scheduler sets the determined clock frequencies and access ratios in the registers of the clock generator 202 and the arbiter 201; and thereby, controls the frequency of each clock supplied to each CPU and the access ratios for access of the shared memory 203 by each CPU (step S1813), and returns to step S1801.

As describe above, according to the multi-core processor system and the scheduling method, the application having the latest start time and a given application for which a startup instruction is issued are not assigned to the same CPU, and the given application is executed immediately. Because the assignment destination for an application is determined based on only the start time set for each CPU, the number of inter-processor communications can be reduced, compared to a conventional case where the assignment destination of an application is determined based on load and priority level. As a result, scheduling overhead can be reduced.

The user is more likely to use an application that has just been started up than an application for which a given time has elapse since the start thereof. In other words, the user is highly likely to use the application having the latest start time and the given application. The execution of these two applications by different CPUs, respectively, therefore, improves the response of the system with respect to the user. Immediate execution of the given application further improves the response of the system with respect to the user.

The start times of the applications assigned to the CPUs are stored in the registers for the CPUs, respectively. As a result, an assignment destination CPU for the given application can be determined without performing inter-processor communication, thereby reducing the number of inter-processor communications and scheduling overhead.

The given application is assigned to the CPU that executes the application having the earliest start time. The CPU that executes the application having the earliest start time is the CPU that is the assignment destination for the application having the earliest start time among the applications having the latest start times among the applications assigned to the CPUs. Applications left unused for a long time from since the start thereof are unlikely to be used by the user. The given application, therefore, can be executed immediately without affecting operations by the user.

The earliest start time related to an assignment destination core to which the given application is assigned is replace with the start time of the given application. As a result, information concerning a start time for determining an assignment destination can be updated easily without performing inter-processor communication.

Information concerning the access frequency of the shared resource or the operation clock for at least one CPU among multiple CPUs is changed based on the start time of the given application, thereby improving the execution performance of the given application.

The operation clock having the highest frequency among multiple operation clocks is supplied to the CPU that executes the given application, thereby improving the execution performance of the given application.

If a startup instruction for another application is not received after the elapse of a given time since the start of the given application, the frequencies of the clocks supplied to the CPUs are changed to a same frequency. At the point in time when the given time elapses, the application that the user is going to use becomes uncertain. For this reason, the performance of the CPUs is made equal, thereby enabling the user to execute an application assigned to any one of the CPUs without the disadvantage of differences in the response of the CPUs. The frequencies of operation clocks supplied to the CPUs are changed to the lowest frequency among the suppliable frequencies, enabling reductions in power consumption.

If a startup instruction for another application is not received after the elapse of the given time since the start of the given application, the access frequencies for access of the shared resource by multiple CPUs are changed to a same frequency. At the point in time when the given time elapses, the application that the user is going to use becomes uncertain. For this reason, the performance of each CPU is made equal, thereby enabling the user to execute an application assigned to any one of the CPUs without the disadvantage of difference in the response of the CPUs.

The scheduling method can be realized by causing any one of CPUs making up the multi-core processor to execute a prepared program. The program may be executed in such a way that the program is stored to a recording medium that can be read by any one of the CPUs making up the multi-core processor, such as the flash ROM 212, and is read out from the recording medium and executed by any one of the CPUs making up the multi-core processor. The program may be distributed via a network, such as the Internet.

The multi-core processor system and the scheduling method improve the response of an application that a user desires to operate and reduce scheduling overhead.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising:
a plurality of processors; and
a scheduler that assigns applications to the processors, wherein
the scheduler upon receiving a startup request for a given application and based on start times of the applications executed by the processors, selects a processor that is to execute the given application.

2. The multi-core processor system according to claim 1, wherein
the start time is stored in a register for each of the processors.

3. The multi-core processor system according to claim 1, wherein
the scheduler assigns the given application to a processor that executes an application having the earliest start time.

4. The multi-core processor system according to claim 3, wherein
the scheduler replaces the earliest start time with a start time of the given application.

5. The multi-core processor system according to claim 1, wherein
information concerning an access frequency of a shared resource or an operation clock for at least one processor among the processors is changed based on a start time of the given application.

6. The multi-core processor system according to claim 1, comprising a clock generating circuit that generates a plurality of operation clocks, wherein
an operation clock of a frequency that is highest among the operation clocks is supplied to the processor that is to execute the given application.

7. The multi-core processor system according to claim 5, wherein
frequencies of clocks supplied to the CPUs are changed to a same frequency, when a startup instruction for another application is not received after an elapse of a given time since a start of the given application.

8. The multi-core processor system according to claim 6, wherein
frequencies of clocks supplied to the CPUs are changed to a same frequency, when a startup instruction for another application is not received after an elapse of a given time since a start of the given application.

9. The multi-core processor system according to claim 7, wherein
an operation clock of a frequency lowest among the operation clocks is supplied to the processors, when a startup instruction for another application is not received after the elapse of the given time since the start of the given application.

10. The multi-core processor system according to claim 8, wherein
an operation clock of a frequency lowest among the operation clocks is supplied to the processors, when a startup instruction for another application is not received after the elapse of the given time since the start of the given application.

11. A scheduling method executed by a computer, the scheduling method comprising:
registering a start time of each application executed by a plurality of processors;
receiving a startup instruction for a given application; and
selecting from among the processors and based on the start times, a processor that is to execute the given application.

12. The scheduling method according to claim 11, wherein
the registering includes registering the start times into registers respectively corresponding to the processors.

13. The scheduling method according to claim 12, comprising
replacing with a start time of the given application, a start time registered in a register corresponding to the processor that is to execute the given application.

14. The scheduling method according to claim 11, comprising
changing information concerning an access frequency of memory or an operation clock for at least one of the processors, based on a start time of the given application.
